(19) United States
(12) Patent Application Publication
(10) Pub. No.: US 2006/0052063 A1
(43) Pub. Date: Mar. 9, 2006

(54) Changeable soft cover for mobile devices

(76) Inventor: Jonathan Charles Lohr, Raleigh, NC (US)

Correspondence Address: COATS & BENNETT/SONY ERICSSON, 1400 CRESCENT GREEN, SUITE 300, CARY, NC, 27511, US

(21) Appl. No.: 10/936,036

(22) Filed: Sep. 8, 2004

(51) Int. Cl. H04Q 7/20

(52) U.S. Cl. 455/90.3

(57) ABSTRACT

A method and apparatus for changing the appearance of a mobile device is described herein. According to the present invention, at least a portion of a housing of an exemplary mobile device comprises a soft cover having a changeable appearance. Responsive to user input, a controller disposed within the housing automatically controls the appearance of the soft cover to control the appearance of the mobile device. According to one or more embodiments of the present invention, the controller may control a color, light pattern, and/or image projected onto or displayed on the soft cover to control the appearance of the mobile device.

### BACKGROUND OF THE INVENTION

The present invention relates generally to the appearance of a mobile device, and more particularly to a changeable cover for a mobile device.

Most families today possess several mobile devices, such as cellular telephones, laptop computers, MP3 players, portable organizers, and the like. In fact, one family often possesses several of a single type of mobile device. For example, each member of a five member family may own a cellular telephone. Typically, these cellular telephones have similar if not identical appearances, which may make it difficult for any one member of the family to quickly identify their personal cellular telephone. As a result, the appearance similarities often lead to confusion. For example, the father may pick up the wrong cellular telephone on his way out the door. Further, a daughter may answer her brother's phone by accident.

To address this problem, various types of after-market add-ons may be used to change the appearance of the mobile device. For example, a consumer may purchase separate covers having different colors and/or appearances. To change the appearance of the mobile device, the consumer simply replaces the old cover with a new cover. Alternatively, a consumer may purchase or create different inserts. By placing one of the inserts underneath a clear cover, the consumer can change the appearance of the mobile device, as shown in U.S. patent application Publication 2003/0134613.

While the above-described examples enable the consumer to change the appearance of a mobile device, they also require the consumer to purchase and keep track of different types of covers or inserts to accommodate various desired appearances.

### SUMMARY OF THE INVENTION

The present invention comprises a method and apparatus for changing the appearance of a mobile device. According to the present invention, a mobile device includes a housing, where at least a portion of the housing comprises a soft cover having a changeable appearance. Responsive to user input, a controller disposed within the housing automatically controls the appearance of the soft cover to control the appearance of the mobile device.

In one exemplary embodiment, the soft cover comprises a transmissive cover. A light source disposed within the housing and controlled by the controller provides a desired color or light pattern to the transmissive cover. As a result, responsive to user input, the controller may control the appearance of the mobile device by controlling the color or light pattern provided by the light source to the transmissive cover.

According to another exemplary embodiment, the light source comprises a projection device. Responsive to user input, the controller controls the projection device to project a desired color, image, or light pattern onto the transmissive cover to control the appearance of the mobile device.

In still another exemplary embodiment, the soft cover comprises a cover display. The cover display is separate from any interface display(s) proximate the housing and used to interface or otherwise provide information to a user with the mobile device. Responsive to user input, the controller controls the appearance of the mobile device by controlling the appearance displayed on the cover display. For example, controlling an image or pattern displayed on the cover display controls the appearance of the mobile device.

### BRIEF DESCRIPTION OF THE DRAWINGS

FIG. 1 illustrates a block diagram of an exemplary mobile device according to one embodiment of the present invention.

FIG. 2 illustrates a block diagram of another exemplary mobile device according to the present invention.

FIG. 3A illustrates an exploded view of one exemplary soft cover system according to the present invention.

FIG. 3B illustrates an exploded view of another exemplary soft cover system according to the present invention.

FIG. 4 illustrates an exploded view of another exemplary soft cover system according to the present invention.

FIGS. 5A and 5B illustrate one exemplary embodiment of a mobile device according to the present invention.

FIG. 6 illustrates a cross-sectional view of an exemplary soft cover system according to the present invention.

FIGS. 7A and 7B illustrate another exemplary embodiment of a mobile device according to the present invention.

FIGS. 8A and 8B illustrate another exemplary embodiment of a mobile device according to the present invention.

FIG. 9 illustrates an exploded view of another exemplary soft cover system according to the present invention.

FIGS. 10A and 10B illustrate another exemplary embodiment of a mobile device according to the present invention.

### DETAILED DESCRIPTION OF THE INVENTION

The present invention describes a mobile device and a corresponding method for changing the appearance of the mobile device responsive to user input. As used herein, the term “mobile device” may include any portable electronic device, such as an MP3 player, CD player, Walkman®, calculator, etc. In addition, the term “mobile device” may include a cellular wireless transceiver with or without a multi-line display; a Personal Communication System (PCS) terminal that may combine a wireless transceiver with data processing, facsimile, and data communication capabilities; a Personal Digital Assistant (PDA) that can include a wireless transceiver, pager, Internet/intranet access, web browser, organizer, calendar, and/or a global positioning system (GPS) receiver; a conventional laptop and/or palmtop receiver; a pager; or any other mobile device that includes a wireless transceiver.

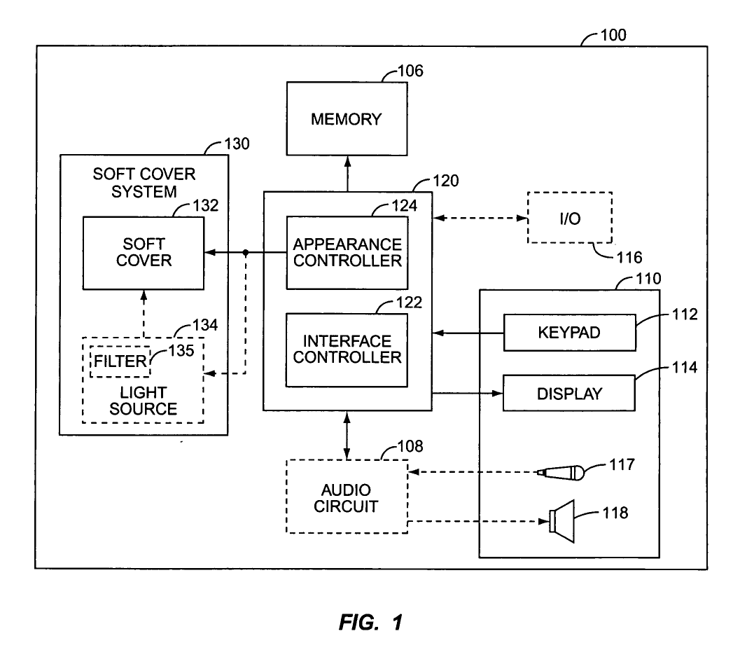

FIG. 1 illustrates a block diagram of an exemplary mobile device 100 according to one or more embodiments of the present invention. Mobile device 100 includes memory 106, optional audio circuit 108, a user interface 110, a system processor 120, and a soft cover system 130. User interface 110 includes one or more user input devices 112 and an interface display 114 to enable the user to interact with and control mobile device 100. The user input devices 112 may include any of a keypad, touchpad, joystick control dials, control buttons, other input devices, or a combination thereof. User input devices 112 allow the operator to enter numbers, characters, or commands, scroll through menus and menu items presented to the user on interface display 114, and make selections. Interface display 114 allows the user to view interface information such as menus and menu items, dialed digits, images, call status information, and output from user applications.

User interface 110 may also include an optional microphone 117 and/or speaker 118. Microphone 117 receives audio input from the user, while speaker 118 projects audible sound to the user. In particular, microphone 117 converts the detected speech and other audible signals into electrical audio signals and speaker 118 converts analog audio signals into audible signals that can be heard by the user. Audio circuit 108 receives analog audio inputs from microphone 117 and provides the basic analog output signals to speaker 118. It will be appreciated that when user interface 110 includes a microphone 117, mobile device 100 may include a voice recognition system (not shown) to receive and process vocal instructions from the user.

System processor 120 performs various processing tasks, including controlling the overall operation of mobile device 100 according to programs stored in memory 106. Memory 106 may include both random access memory (RAM) and read-only memory (ROM). Computer program instructions and data required for operation of mobile device 100 are stored in non-volatile memory, such as EPROM, EEPROM, and/or flash memory, which may be implemented as discrete devices, stacked devices, or integrated with system processor 120.

The system processor 120 may be implemented in hardware, firmware, software, or a combination thereof, and may comprise a single microprocessor or multiple microprocessors. The microprocessors may be general purpose microprocessors, digital signal processors, or other special purpose processors. Functions performed by system processor 120 may include signal processing, image processing, and/or control of the overall operation of mobile device 100.

As shown in FIG. 1, system processor 120 includes an interface controller 122. Interface controller 122 controls interface display 114 to display the appropriate menus, menu items, dialed digits, images, output from user applications, and other interface information, as is well understood in the art. In accordance with the present invention, and as discussed in greater detail below, signal processor 120 also includes an appearance controller 124.

Mobile device 100 may also include an optional input/output (I/O) port 116 for coupling the mobile device 100 to an external device. I/O port 116 may comprise any type of known serial port, parallel port, or combination serial and parallel port. Exemplary I/O ports 116 include a Small Computer System Interface (SCSI) port, a Universal Serial Bus (USB) port, an Ethernet port, or any I/O port used to download information from an external device to system processor 120 and/or to memory 106. The downloaded information may include, but is not limited to, music files, video files, and the like. In addition, as discussed further below, I/O port 116 may be used to download one or more desired appearances for mobile device 100.

FIG. 1 represents a generic mobile device 100, such as a CD player, tape player, calculator, MP3 player, etc. It will be appreciated that mobile device 100 may also include wireless communication capabilities. To that end, mobile device 100 may include at least one transceiver 102 and antenna 104, as shown in FIG. 2. Transceiver 102 is coupled to antenna 104 for receiving and transmitting wireless signals. The transceiver 102 may comprise a fully functional cellular radio transceiver, which may operate according to any known standard, including the standards known generally as the Global System for Mobile Communications (GSM), TIA/EIA-136, cdmaOne, cdma2000, UMTS, and Wideband CDMA. In addition, transceiver 102 may include baseband processing circuits to process signals transmitted and received by the transceiver 102. Alternatively, baseband processing circuits may be incorporated in the system processor 120.

Further, transceiver 102 may also comprise a short-range wireless transceiver, such as a Bluetooth® transceiver 102. As understood by those skilled in the art, Bluetooth® is a universal radio interface that enables two or more wireless devices to communicate wirelessly via short-range ad hoc networks. Jaap Haartsen in Ericsson Review No. 3, 1998, provides further details regarding Bluetooth® technology in “Bluetooth®—The universal radio interface for ad hoc, wireless connectivity.” While the present application may use the term “Bluetooth® transceiver” and “Bluetooth® network” to refer to a wireless interface for short-range communications, those skilled in the art will appreciate that the present invention is not limited to Bluetooth® systems and equipment, and that other short-range wireless interfaces, e.g., infra-red interfaces, are equally applicable.

The mobile device 100 according to the present invention also includes a soft cover system 130, as shown in FIGS. 1 and 2. As discussed further below, soft cover system 130 has a changeable appearance that changes the appearance of mobile device 100 responsive to user input. In one exemplary embodiment, soft cover system 130 includes at least one soft cover 132, and optionally, one or more light sources 134. According to the present invention, at least a portion of a housing associated with the mobile device 100 comprises soft cover 132 having a changeable appearance. For example, a faceplate, a backplate, or any portion of the faceplate or backplate of a mobile device 100 may comprise a soft cover 132. According to the present invention, appearance controller 124 interfaces with soft cover system 130 to change the appearance of mobile device 100 by changing the appearance of soft cover 132 responsive to user input.

In one exemplary embodiment, soft cover 132 may comprise a transmissive cover 132 that transmits visible light provided by light source 134. For example, transmissive cover 132 may comprise a transmissive plastic panel, such as a transparent plastic panel or glass panel, or transmissive cover 132 may comprise a transmissive frame that contains a transmissive material, such as a transmissive gel, to transmit the light provided by light source 134. As used herein, the term “transmissive” should be understood to represent that characteristic of a medium that permits the transmission of visible electro-magnetic radiation. The term transmissive encompasses, but is not limited to, the terms transparent and translucent.

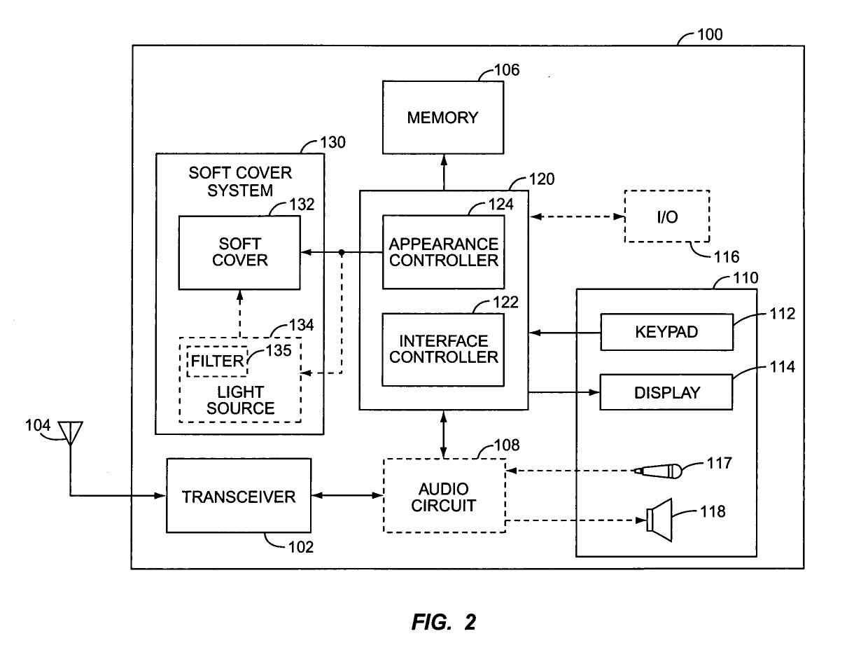

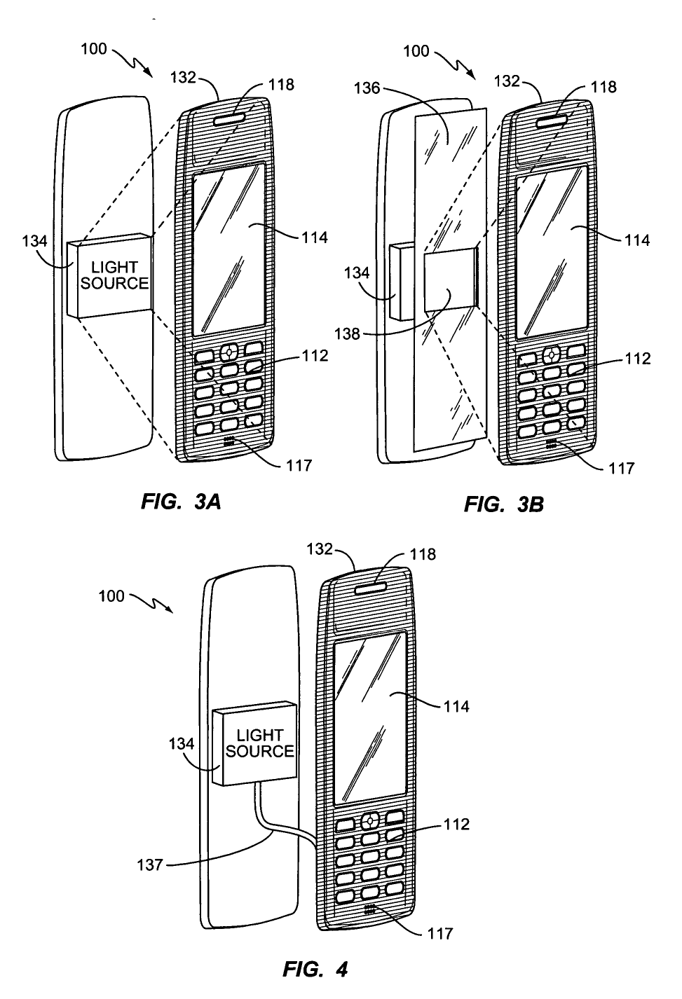

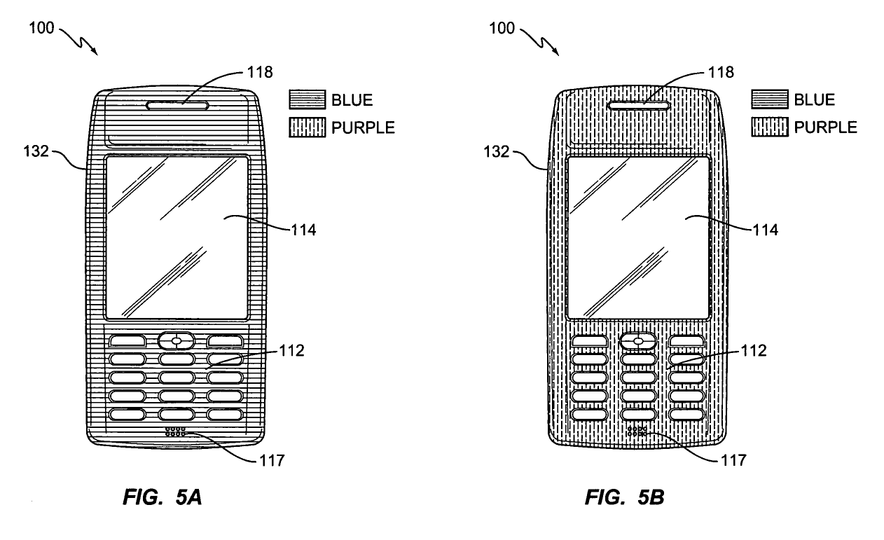

Transmissive cover 132 transmits light provided by light source 134 such that the mobile device 100 radiates light at a desired color. As shown in FIG. 3A, light may be provided to transmissive cover 132 via a free-space interface. In this embodiment, light source 134 projects the light onto all or any portion of transmissive cover 132. The provided light passes through the transmissive cover 132 to project a desired color to the user. Responsive to user input, appearance controller 124 may change the color of the mobile device 100 by changing the color provided by light source 134 to transmissive cover 132. For example, responsive to a user selecting a blue appearance, appearance controller 124 directs light source 134 to provide a blue light to the transmissive cover 132, as shown in FIG. 5A.

Light source 134 may comprise any known light source, such as a light emitting diode (LED), laser, etc. It will be appreciated that light source 134 may comprise an individual light source, i.e., an individual LED, for each color included in light source 134. Alternatively, light source 134 may include different groups of individual light sources, such as different groups of LEDs, where each group radiates a different color of light. It will also be appreciated that light source 134 may comprise a single light source that radiates light at a specified color responsive to control signals provided by appearance controller 124. By activating one or more individual light sources or groups of light sources, appearance controller 124 may control the color of light output by light source 134 and provided to transmissive cover 132, and therefore, may control the color of the mobile device 100. For example, responsive to a user selecting a blue appearance, appearance controller 124 may activate one or more blue LEDs. By providing the blue light from the blue LED(s) to the transmissive cover 132, the light source 134 causes the transmissive cover 132, and therefore the mobile device 100, to take on a blue color, as shown in FIG. 5A. Alternatively, responsive to the user selecting a purple appearance, appearance controller 124 may activate one or more red LEDs and one or more blue LEDs so that the mobile device 100 takes on a purple color, as shown in FIG. 5B.

While transmitting light emitted by light source 134 through transmissive cover 132 will project a desired color to the user, unintended light scattering within the transmissive cover 132 may cause light to be reflected away from the user and into the mobile device 100, which causes inefficient light transmission. To address this, a reflective surface 136, such as a reflective panel or coating, may be positioned or placed on the back of transmissive cover 132, as shown in FIG. 3B, to reflect the scattered light back towards the user and therefore to reduce the inherent losses associated with scattering in transmissive cover 132. Reflective surface 136 is at least partially reflective to help re-direct the light through transmissive cover 132, and therefore, to increase the percentage of the light transmitted through the transmissive cover to the user. In this embodiment, coating 136 may include one or more openings 138 that operate as input ports to allow the light from light source 134 to enter the transmissive cover 132, as shown in FIG. 3B.

Further, while the free-space interface provides the light to transmissive cover 132, there are also inherent losses associated with free-space propagation of light that may cause undesirable losses in the light provided to transmissive cover 132. For example, the light may reflect off of or be absorbed by components within mobile device 100. To reduce these free-space losses, light source 134 may include a light pipe 137, such as an optical fiber, to directly channel the light generated by light source 134 to the transmissive cover 132, as shown in FIG. 4. In this embodiment, light pipe 137 provides the light directly to the transmissive cover 132.

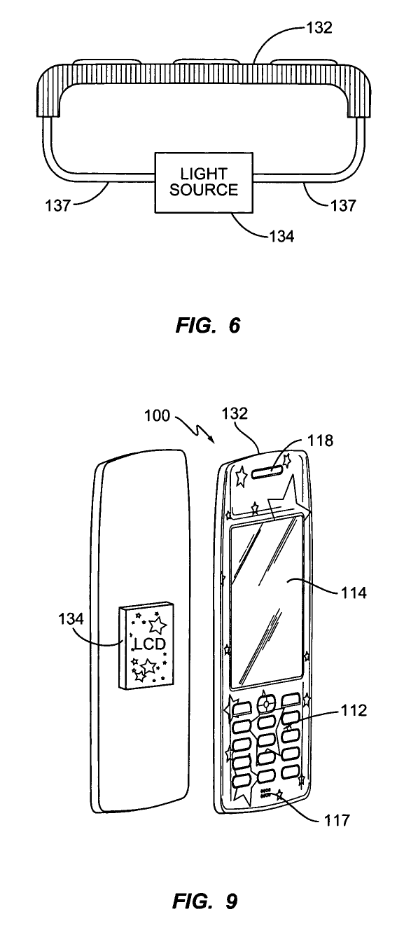

The above-described soft cover 132 comprises a transmissive cover 132. However, other soft covers may also be used to transmit colored light to a user. For example, soft cover 132 may include a light guide or may include multiple light guides for transmitting light through soft cover 132 and radiating light to the user. In one exemplary embodiment, shown in FIG. 6, a light pipe 137 may provide light from light source 134 to an edge or opening in the light guide 132, to provide the light to the light guide(s). The light guide(s) in turn radiate the provided light to the user.

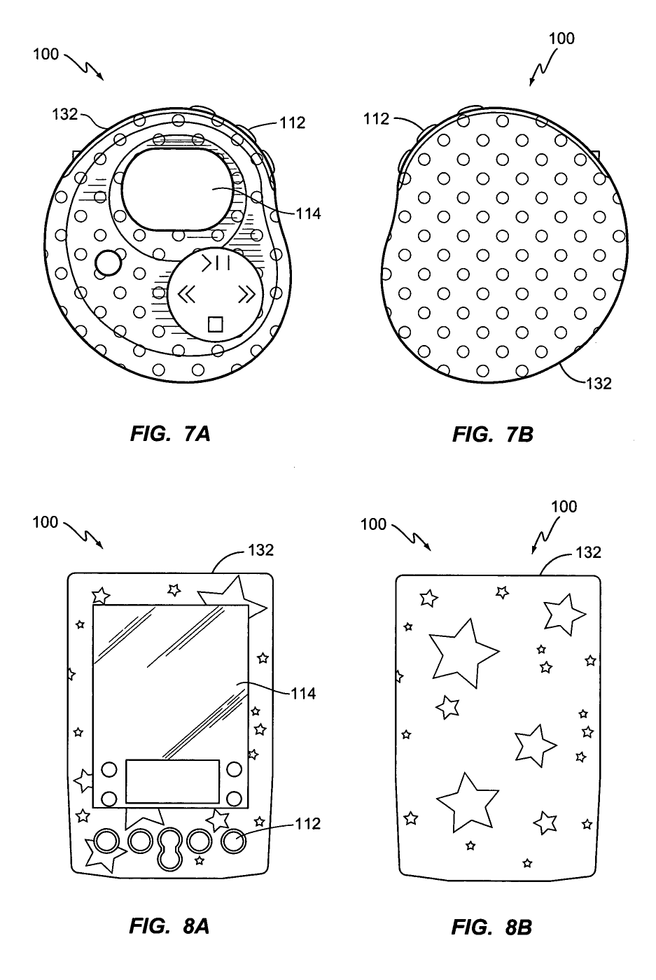

The above describes changing the appearance of the mobile device 100 by changing the color of the soft cover 132 associated with mobile device 100. However, the present invention is not so limited. Appearance controller 124 may also control light source 134 to provide a desired light pattern to the transmissive cover 132 to change the appearance of the mobile device 100 to that of the desired light pattern, such as the polka-dot pattern or the star pattern shown in FIGS. 7A-7B and 8A-8B, respectively.

It will be appreciated by those skilled in the art that there are different ways to implement a desired light pattern. For example, multiple light sources 134 may be positioned proximate different sections of transmissive cover 132 or proximate different openings 136 of transmissive cover 132 to provide different colors, and therefore different light patterns, to different regions of the transmissive cover 132. Similarly, different colors may be provided to different light guides in soft cover 132.

To change the light pattern, appearance controller 124 controls the light source 134 responsive to user input. For example, as shown in FIGS. 7A and 7B, appearance controller 124 may control one or more light sources 134 to create a polka-dot pattern on the mobile device 100. Alternatively, light source 134 may include one or more selectable filters 135 that provide a desired light pattern to the transmissive cover 132. For example, light source 134 may include a star filter 135 to generate the star pattern shown in FIGS. 8A and 8B. While FIGS. 1 and 2 illustrate the light filter 135 as being part of the light source 134, those skilled in the art will appreciate that light filter 135 may be external from light source 134.

In still another embodiment, light source 134 may comprise a projector 134, where projector 134 projects a desired color or light pattern onto the transmissive cover 132, as shown in FIG. 9. As is understood in the art, when used as a projection screen, transmissive cover 132 typically comprises a highly transmissive screen, and may also include diffusers and/or directional correlators to maximize brightness and contrast. Projector 134 may be any light or image projection device known in the art, such as a liquid crystal projector or a thin film transistor projector. In any event, to provide a desired appearance to the mobile device 100, appearance controller 124 controls projector 134 to project the desired appearance onto the transmissive cover 134.

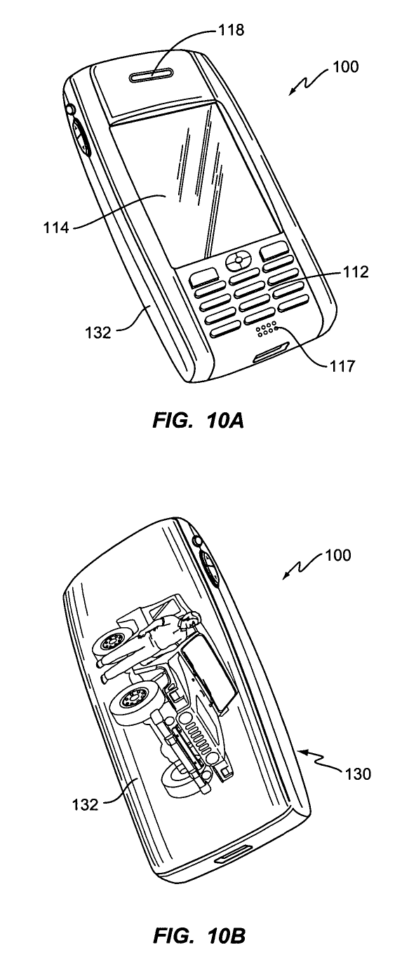

It will also be appreciated that the present invention is not limited to the color or light patterns discussed above. Computer generated images or patterns, such as digital photographs, clip art, drawings, etc., my also be used to change the appearance of the mobile device 100, as shown in FIGS. 10A and 10B. For example, projector 134 may project a computer generated image or other pattern onto the transmissive cover 132.

The above describes how a transmissive cover or light guide working with a light source 134 may change the appearance of a mobile device 100. However, it will be appreciated that other soft cover systems 130 may also be used independent of a separate light source 134. For example, an exemplary soft cover 132 according to one embodiment may comprise any known display screen that displays a desired color, light pattern, or computer-generated image or pattern. In this embodiment, the soft cover display screens 132 are different from the interface display 114 in that the soft cover display screen 132 is controlled by appearance controller 124 to display a desired appearance, while interface controller 122 controls the interface display 114 to display interface information, such as menus, options, dialed digits, etc. Therefore, as used herein, the soft cover display 132 does not include the interface display 114.

According to one exemplary embodiment, appearance controller 124 controls soft cover display 132 responsive to user input to display a desired appearance, such as a desired color, light pattern, computer generated image, etc. To that end, soft cover display 132 may comprise any known display, such as a liquid crystal display (LCD), an organic light emitting diode display (OLED), and a flat panel display. Further, to conform the soft cover display 132 to the general shape of a mobile device 100, soft cover display 132 may comprise a flexible OLED (FOLED) or a flexible flat panel display. As a result, the soft cover display 132 may also cover corners, edges, and other non-flat portions of mobile device 100.

The above describes a mobile device 100 with a housing that comprises a soft cover 132 having a changeable appearance responsive to user input. It will be appreciated that soft cover 132 may be made up of one or more soft covers 132 that cover one or more portions of mobile device 100, where each soft cover 132 may be a soft cover display or may be associated with a separate light source. As a result, the appearance of mobile device 100 may comprise a single color or light pattern shown on all soft covers 132, or the appearance may comprise multiple colors and/or light patterns respectively shown on different soft covers 132. In addition, different soft covers 132 may be used to display different portions of a single light pattern or image. For example, the back of a mobile device housing may comprise two separate soft covers 132. To create the appearance of the man standing next to the jeep shown in FIG. 10B, one soft cover 132 may provide the one half of the image, while the other soft cover 132 may provide the other half of the image.

Further, mobile device 100 may include multiple light sources 134 for each soft cover 132. As a result, the appearance of mobile device 100 may comprise a single color or light pattern provided by each light source 134, or the appearance may comprise multiple colors and/or light patterns respectively provided by each light source 134. For example, each light source 134 for each soft cover may provide a blue light to the soft cover 132 to create a blue appearance for the mobile device 100, as shown in FIG. 5A. Alternatively, each light source 134 may provide a different color to provide a multi-color appearance or to create a light pattern out of multiple colors, such as the polka dot appearance shown in FIGS. 7A and 7B. In addition, different light sources 134 may be used to display different portions of a single light pattern or image.

As discussed above, appearance controller 124 changes the appearance of soft cover 132 to change the appearance of the mobile device 100 responsive to user input. The user may provide the input by any known means. For example, the user may navigate one or more menus displayed on interface display 114 to select a desired mobile device color. Once selected, appearance controller 124 modifies the light source 134 or soft cover display 132 to change the appearance of the mobile device 100 to the color selected by the user. Alternatively, the user may provide a voice command or activate a specific control button on the housing to select a desired color.

According to one embodiment, the user selects a desired appearance from a plurality of appearance options stored in memory 106. These options may be provided by the manufacturer or they may be acquired by the mobile device by any known means. For example, a user may download one or more appearances via I/O port 116 from any known source, such as an Internet web page, a computer database, etc. Further, a mobile device 100 having a transceiver 102 may utilize transceiver 102 to download one or more appearances via a short-range or a cellular wireless interface. In any event, a user may acquire and store a desired light pattern or computer generated image by downloading the light pattern or computer generated image from an external database. For example, a user may download a family photograph from a digital camera or a home computer. Similarly, a sports fan may download an image or icon associated with their favorite team. In addition, the user may create their own mobile device appearances with any graphics software, and download the user-generated appearances to the mobile device 100 via I/P port 116 or transceiver 102. In any event, once acquired, the user may select the desired appearance, thereby causing appearance controller 124 to retrieve the selected appearance from memory 106 and change the appearance of the mobile device 100 accordingly.

The above describes a mobile device 100 with a housing comprising a soft cover 132 having a changeable appearance responsive to user input. As a result, the user may simply select a desired appearance using any known input means to activate an appearance change. Because the appearance change is implemented electronically, changing the appearance does not require any hardware changes or assembly. Further, because the change is implemented electronically, the appearance options available to the user are only limited by the user's imagination.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A mobile device comprising:
a housing, wherein at least a portion of the housing comprises a soft cover having a changeable appearance; and
a controller disposed within the housing, said controller configured to control the appearance of the mobile device by controlling the appearance of the soft cover responsive to user input.

2. The mobile device of claim 1 wherein the soft cover comprises a transmissive cover.

3. The mobile device of claim 1 wherein the soft cover comprises one or more light guides.

4. The mobile device of claim 1 further comprising a light source disposed within the housing and controlled by the controller to provide a selected color or light pattern to the soft cover.

5. The mobile device of claim 4 wherein the light source comprises at least one light emitting diode.

6. The mobile device of claim 5 wherein the light source further comprises at least one optical fiber coupled to the at least one light emitting diode.

7. The mobile device of claim 4 further comprising at least one light filter to filter the light source to provide the selected color or light pattern to the soft cover.

8. The mobile device of claim 4 wherein the light source comprises a projection device.

9. The mobile device of claim 8 wherein the transmissive cover transmits an appearance projected by the projection device, and wherein the controller controls the appearance of the mobile device by controlling the output of the projection device responsive to user input.

10. The mobile device of claim 8 wherein the projection device comprises a liquid crystal projection system.

11. The mobile device of claim 1 wherein the soft cover comprises a soft cover display that conforms to a shape of the mobile device, and wherein the controller controls the appearance of the mobile device by controlling the soft cover display.

12. The mobile device of claim 11 further comprising:
an interface display disposed proximate the housing and independent from the soft cover display; and
an interface processor configured to control interface information displayed on the interface display.

13. The mobile device of claim 12 wherein the soft cover display comprises at least one of a liquid crystal display, an organic light emitting display, a flexible organic light emitting display, and a flexible flat panel display.

14. The mobile device of claim 1 further comprising at least one of a hardware input/output port and a wireless transceiver for acquiring one or more appearances from an external source.

15. A method of controlling an appearance of a mobile device comprising:
providing the mobile device with a housing, wherein at least a portion of the housing comprises a soft cover having a changeable appearance; and
controlling the appearance of the mobile device by controlling the appearance of the soft cover responsive to user input.

16. The method of claim 15 wherein the soft cover comprises a transmissive cover and wherein controlling the appearance of the soft cover comprises controlling a light source disposed in the housing to provide a desired color or light pattern to the transmissive cover responsive to user input.

17. The method of claim 16 wherein controlling the light source comprises filtering the light source to provide the desired color or light pattern.

18. The method of claim 15 wherein the soft cover comprises a soft cover display and wherein controlling the appearance of the soft cover comprises controlling the soft cover display to display a selected appearance responsive to the user input.

19. The method of claim 15 wherein the soft cover comprises a transmissive cover and wherein controlling the appearance of the soft cover comprises controlling a projection source to project a selected appearance onto the transmissive cover responsive to the user input.

20. The method of claim 15 further comprising acquiring one or more appearances from an external source.

21. The method of claim 20 wherein acquiring the one or more appearances comprises acquiring the one or more appearances via a wireless interface.

22. The method of claim 20 wherein acquiring the one or more appearances comprises acquiring the one or more appearances from a memory disposed within the housing.

23. The method of claim 20 wherein acquiring the one or more appearances comprises acquiring the one or more appearances via a hardware input/output interface.

24. A mobile device comprising:
a housing, wherein at least a portion of the housing comprises a transmissive cover having a changeable appearance;
a light source disposed within said housing to provide a color or light pattern to the transmissive cover; and
a controller disposed within said housing, said controller configured to control the appearance of the mobile device by controlling the appearance provided by the light source.

25. The mobile device of claim 24 wherein the light source comprises a projection device and wherein the controller controls the appearance of the mobile device by controlling the appearance projected by the projection device.

26. The mobile device of claim 25 wherein the projection device comprises one of a liquid crystal or a thin film transistor projection device.

27. The mobile device of claim 24 wherein the light source comprises at least one light emitting diode.

28. The mobile device of claim 24 further comprising at least one light filter controlled by the controller to filter the light source to provide the color or light pattern to the transmissive cover responsive to user input.

29. A mobile device comprising:
a housing, wherein at least a portion of the housing comprises a soft cover display that conforms to a shape of the mobile device, said soft cover display having a changeable appearance; and
a controller disposed within said housing, said controller configured to control the appearance of the mobile device by controlling the appearance of the soft cover display.

30. The mobile device of claim 29 wherein the soft cover display comprises at least one of a liquid crystal display, a flexible organic light emitting display, and a flexible flat panel display.
